(19) United States
(12) Patent Application Publication
(10) Pub. No.: US 2013/0297447 A1
(43) Pub. Date: Nov. 7, 2013

(54) RECOMMENDED CONTENT PROVIDING APPARATUS, RECOMMENDED CONTENT PROVIDING PROGRAM AND RECOMMENDED CONTENT PROVIDING METHOD

(71) Applicant: PANASONIC CORPORATION, Osaka (JP)

(72) Inventor: Yoshifumi SAKATA, Osaka (JP)

(21) Appl. No.: 13/935,448

(22) Filed: Jul. 3, 2013

Related U.S. Application Data
(63) Continuation of application No. PCT/JP2012/003922, filed on Jun. 15, 2012.

(30) Foreign Application Priority Data
Feb. 9, 2012 (JP) 2012-025780

(51) Int. Cl. G06Q 30/06

(52) U.S. Cl. CPC G06Q 30/0631
USPC 705/26.7

(57) ABSTRACT

A recommended content providing apparatus according to the present disclosure includes: an obtaining unit configured to obtain information on display of a plurality of recommended content items; a short-term impression judging unit configured to obtain impression duration of a viewing content item viewed by a user; and a recommended content determining unit configured to modify the information on display of one of the recommended content items which belongs to a same content category as a content category to which the viewing content item belongs, based on the impression duration of the viewing content item.

### CROSS REFERENCE TO RELATED APPLICATION

This is a continuation application of PCT International Application No. PCT/JP2012/003922 filed on Jun. 15, 2012, designating the United States of America, which is based on and claims priority of Japanese Patent Application No. 2012-025780 filed on Feb. 9, 2012. The entire disclosures of the above-identified applications, including the specifications, drawings and claims are incorporated herein by reference in their entirety.

### FIELD

The present disclosure relates to a recommended content providing apparatus and so on in a content viewing service.

### BACKGROUND

In recent years, a content viewing service, such as a television broadcast, in which a viewing content item and the like is provided to a user is becoming popular. In such a content viewing service, a content recommendation service may be provided in which a content item belonging to a category suitable for a user is recommended, according to user's preference, that is, user's likes or dislikes against things.

In the content recommendation service, examples of an algorithm usable for determining a recommended content item to be provided to a user include an algorithm used for determining a recommended content item by estimating preference information indicating the user's preference based on a user's viewing history.

For the content recommendation service using the user's viewing history, various methods have been proposed for providing a recommended content item more suitable for the user.

Examples of technique for providing the recommended content item more suitable for a user include an apparatus which recommends a content item, using not only long-term preference information estimated from a user's viewing history for a long term but also short-term preference information estimated from a user's viewing history for a short term (for example, see Patent Literature (PTL) 1). Since the more the viewing histories exist, the higher the accuracy in the preference information becomes, the apparatus disclosed in PTL 1 employs the long-term preference information which is estimated based on the viewing history for a long term. In addition to the above, the short-term preference information is also employed which is estimated from the viewing history for a short term, in order to reflect short-term statuses including a case when a user feels like viewing a content item which is different from usual ones, and thus is not reflected on the long-term preference information.

Another example of the technique for providing a recommended content item more suitable for a user has also been disclosed. The example is directed to an apparatus which eliminates a content item displayed (reproduced) in a short time (a content item on which zapping is performed), as a content item which is unattractive to a user (for example, see PTL 2).

In view of the above, both PTL 1 and PTL 2 adopt a method for estimating the short-term preference information based on the user's viewing history in a short-term.

### CITATION LIST

### Patent Literature

[PTL 1] Japanese unexamined patent application publication No. 2006-215643
[PTL 2] Japanese unexamined patent application publication No. 2011-211586

### SUMMARY

### Technical Problem

However, a method for estimating preference information disclosed in PTLs 1 and 2 is based only on a viewing history, so that features or other factors of a content item have not been considered.

The present disclosure aims to provide a recommended content providing apparatus and the like capable of providing a recommended content item more suitable for a user.

### Solution to Problem

In order to solve the above problem, a content providing apparatus according to an aspect of the present disclosure includes: an obtaining unit configured to obtain information on display of a plurality of recommended content items; a short-term impression judging unit configured to obtain impression duration of a viewing content item viewed by a user; and a recommended content determining unit configured to modify the information on display of one of the recommended content items which belongs to a same content category as a content category to which the viewing content item belongs, based on the impression duration of the viewing content item.

Furthermore, in order to solve the above problem, a content providing program, according to an aspect of the present disclosure, which causes a computer to execute determination on a content item to be provided to a user, includes: a step of obtaining information on display of a plurality of recommended content items; a step of obtaining impression duration of a viewing content item viewed by a user; and a step of modifying the information on display of one of the recommended content items which belongs to a same content category as a content category to which the viewing content item belongs, based on the impression duration of the viewing content item.

Furthermore, in order to solve the above problem, a content providing method according to an aspect of the present disclosure includes: a step of obtaining information on display of a plurality of recommended content items; a step of obtaining impression duration of a viewing content item viewed by a user; and a step of modifying the information on display of one of the recommended content items which belongs to a same content category as a content category to which the viewing content item belongs, based on the impression duration of the viewing content item.

### Advantageous Effects

With a content providing apparatus and the like according to the present disclosure, it is possible to provide a recommended content item which is more suitable for a user in response to impression duration of a content item.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a graph which shows a relationship between an initial strength of “just-viewed feeling” and duration of the “just-viewed feeling”.

FIG. 2 is a block diagram which shows a configuration example of a content providing apparatus to be installed in a television.

FIG. 3 is a table which shows metadata of a viewing content item.

FIG. 4 is a table which shows a short-term impression determination table.

FIG. 5 is a table which shows a short-term impression history table.

FIG. 6 is a table which shows metadata of a first recommended content item.

FIG. 7 is a diagram which shows transition in screens of a television.

FIG. 8A is a flowchart which shows procedures in producing a short-term impression history table.

FIG. 8B is a flowchart which shows procedures in providing the recommended content item.

FIG. 9 is a table which shows data of a second recommended content item.

### DESCRIPTION OF EMBODIMENT

### Embodiment 1

[Knowledge which Forms the Basis of the Present Disclosure]

In relation to determination on a recommended content item, features of a content item include, for example, impression duration which is a time period from user's first viewing at a content item to subsequent user's demand for viewing the content item again. For example, a content item which can be viewed once a week, like a movie content item, has relatively long impression duration. Other examples include a content item which can be viewed everyday, like a series of drama content item, has relatively short impression duration. In other words, content items are different from each other in the impression duration, depending on a feature indicating whether or not each of the content items belongs to the category or the series in issue.

In the respective apparatuses disclosed in PTL 1 and PTL 2, such features of the content items are not considered. Thus, since these apparatuses do not cope with a difference in the impression duration, accuracy for the recommended content item has been insufficient.

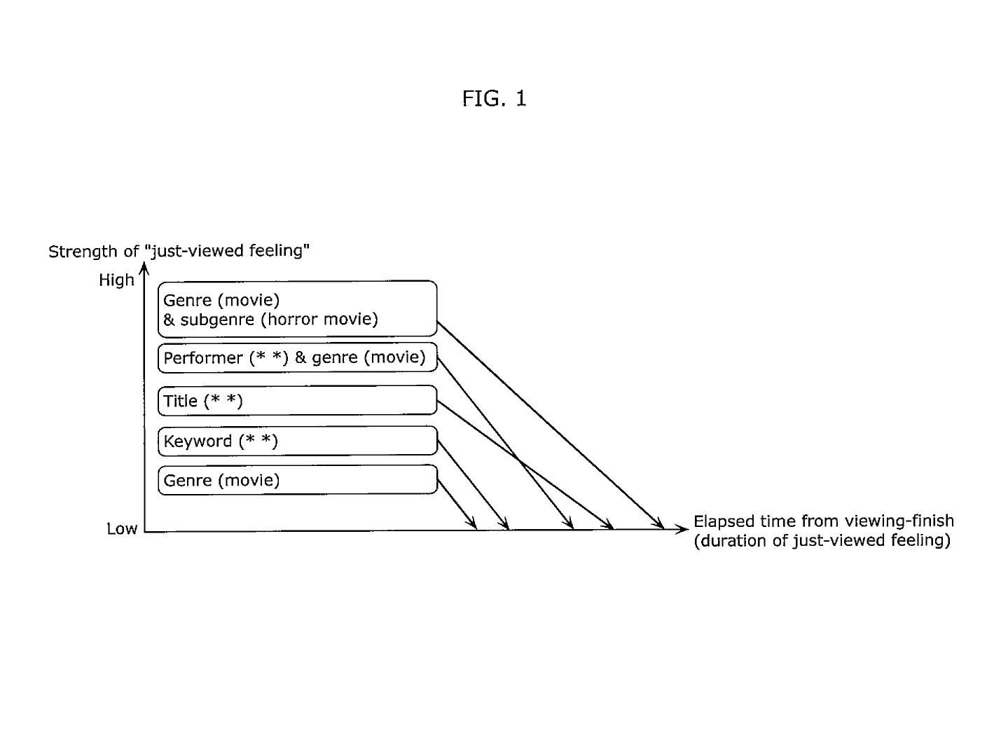

The aforementioned impression duration is described in detail, referring to FIG. 1. FIG. 1 is a graph which shows a relationship, in relation to “just-viewed feeling”, between initial strength and impression duration for each of content categories of content items.

It should be noted that the “just-viewed feeling” indicates strength of the short-term impression on a viewing content item, and exhibits the highest strength immediately after finish of viewing and decreases as time passes. Impression duration covers a time period from a time point at which the viewing is finished to a time point at which the “just-viewed feeling” decreases to zero.

Here, the description is given taking, as an example, a case in which the content item is a TV program.

Content items are categorized depending on a “genre” such as movie or drama, a “subgenre” obtained by breaking down the genre in more detail, a “performer” indicating a name of a person who appears in a content item, a “title” of a content item, attribution of a “keyword” and the like indicative of a proper name used for searching a content item, or a combination of them.

In FIG. 1, the vertical axis indicates strength in the “just-viewed feeling”, while the horizontal axis indicates elapsed time from the finish of viewing the content item.

FIG. 1 shows frames in which categories of the respective content items are exemplified. Some of the frames indicate therein the categories of the content items, such as a performer (**), a title (**), a keyword (**), where (**) is allocated to a proper name. The above is employed because each of the initial strength and the impression duration in the “just-viewed feeling” is differentiated depending on a proper personal name, a proper title, a proper keyword, and the like.

The graphs indicated by downward sloping arrows show relationships between the strength and the elapsed time in the “just-viewed feeling” for the respective content categories indicated by the frames positioned at starting points of the respective arrows. Values in the vertical axis, which correspond to the starting points of the arrows, show the respective initial strength of the “just-viewed feeling”, while values in the horizontal axis, which correspond to end points of the arrows indicate the respective impression duration of the “just-viewed feeling”.

FIG. 1 shows an example in which the content item categorized in “genre (movie) and subgenre (horror movie)” is highest in the initial strength and longest in the duration, for the “just-viewed feeling”. The content item categorized in “genre (movie) and subgenre (horror movie)” is, for example, a content item which a user would like to view once a week. The content item of a typical movie, which is categorized in “genre (movie)” shows lowest initial strength and shortest duration time, for the just-viewed feeling. In other words, the content item categorized in “genre (movie)” is a content item which the user would like to view a few days later or a few hours later.

As aforementioned, each of the initial strength and the duration of the “just-viewed feeling” is differentiated depending on genres of content items, titles of content items (program titles for TV content items), keywords (for example, a proper noun, such as a personal name or a place name), and so on, or a combination (category) of them.

It should be noted that the “just-viewed feeling” is appropriate as an index for determining a content item to be provided, since the “just-viewed feeling” serves as an index which can be set for each of features (categories) including a genre, performer, and the like for a content item, based on definite result of a viewed history indicating that the user actually viewed the content item. The initial strength and the impression duration of the “just-viewed feeing” are recorded for each of categories of content items in advance, so that the “just-viewed feeling” becomes available as a useful index (parameter) for determining a content item to be provided which is more suitable for a user.

Therefore, in an embodiment to be described below, a recommended content item is determined using, in addition to the viewed history, the “just-viewed feeling” which is short-term impression, unlike the method for estimating preference using only the viewed history as disclosed in PTL 1 and PTL 2.

The content providing apparatus according to an aspect of the present disclosure includes an obtaining unit configured to obtain information on display of a plurality of recommended content items; a short-term impression judging unit configured to obtain impression duration of a viewing content item viewed by a user; and a recommended content determining unit configured to modify the information on display of one of the recommended content items which belongs to a same content category as a content category to which the viewing content item belongs, based on the impression duration of the viewing content item.

According to the content providing apparatus configured as above, the recommended content item to be provided can be determined according to the impression duration.

If the impression duration is not considered as in the apparatuses disclosed in PTL 1 and PTL 2, the content item belonging to a category which shows a relatively short impression duration tends to be viewed many times. Accordingly, such a content item is likely to be preferentially determined as the content item to be provided. In contrast, a content item belonging to a category which shows a relatively long impression duration tends to be viewed less than the content item with the short impression duration. Accordingly, even if the content item is suitable for a user, the content item is more likely to become low in priority or not to be determined as the content item to be provided.

On the other hand, according to the content providing apparatus configured as above, the recommended content item to be provided can be determined according to the impression duration. Therefore, the content item which belongs to a category showing long impression duration and thus is relatively less viewed, but is suitable for a user can be provided to the user with high accuracy and at a timing proper to the user.

Furthermore, the content providing apparatus configured as described above can provide a content item more suitable for a user by using the impression duration, to thereby reduce an operation amount imposed on the user for determining the content item to be viewed among the provided content items. In other words, an effect can be expected that power consumption in the content providing apparatus upon the operation is reduced.

Furthermore, the obtaining unit may be configured to obtain recommendation degrees of the recommended content items, as the information on display, and the recommended content determining unit is configured to modify at least one of the recommendation degrees which corresponds to the recommended content item.

The recommended content determining unit may further be configured to determine a priority order for displaying the recommended content items, based on the modified recommendation degrees, for example.

The recommended content determining unit may further be configured to determine whether or not the recommended content items are to be displayed, based on the modified recommendation degrees, for example.

The short-term impression judging unit may be configured to obtain viewing-finish time of the viewing content item in addition to the impression duration, and the recommended content determining unit may be configured to modify the information on display, based on impression duration of a viewing content item which does not accomplish the impression duration from the viewing-finish time, among viewing content items including the viewing content item, for example.

The recommended content determining unit may be configured to modify each of the recommendation degrees to reduce the recommendation degree greater for the recommended content item corresponding to the viewing content item the impression duration of which is longer, for example.

The short-term impression judging unit may be configured to obtain viewing-finish time of the viewing content item and initial strength of impression on the viewing content item, in addition to the impression duration, and the recommended content determining unit may be configured to calculate, for the viewing content item, current strength indicating strength of current impression, based on elapsed time from the viewing-finish time, the impression duration, and the initial strength, to thereby modify the information on display based on the current strength, for example.

The recommended content determining unit may be configured to calculate the current strength by multiplying the initial strength by a ratio, to the impression duration, of a difference between the impression duration and the elapsed time, for example.

The obtaining unit may be configured to obtain a recommendation degree of each of the recommended content items, as the information on display, and the recommended content determining unit may be configured to calculate a value, as a weight coefficient, by dividing a difference between a maximum value of the initial strength and a value of the current strength by the maximum value of the initial strength, and to multiply the recommendation degree by the weight coefficient, to thereby modify the recommendation degree, for example.

The obtaining unit may be configured to obtain a recommendation degree of each of the recommended content items, as the information on display, and the recommended content determining unit may be configured to modify the recommendation degree to reduce the recommendation degree greater for the recommended content item corresponding to the viewing content item the impression duration of which is longer, for example.

The content category may be specified by at least any one of a content genre, a keyword contained in metadata of the viewing content item, a personal name who appears in the viewing content item, a title of the viewing content item, and a combination thereof, for example.

A content providing program according to an aspect of the present disclosure causes a computer to execute determination on a content item to be provided to a user. The content providing program includes: a step of obtaining information on display of a plurality of recommended content items; a step of obtaining impression duration of a viewing content item viewed by a user; and a step of modifying the information on display of one of the recommended content items which belongs to a same content category as a content category to which the viewing content item belongs, based on the impression duration of the viewing content item.

A content providing method according to an aspect of the present disclosure includes: a step of obtaining information on display of a plurality of recommended content items; a step of obtaining impression duration of a viewing content item viewed by a user; and a step of modifying the information on display of one of the recommended content items which belongs to a same content category as a content category to which the viewing content item belongs, based on the impression duration of the viewing content item.

Hereinafter, an embodiment of the present disclosure is described in detail, referring to the drawings. It should be noted that the every embodiment to be described below indicates a specific example desirable for the present disclosure. The below-described embodiment shows, as an example, components, placement and connection of the components, processing, an order of the processing, and the like, and do not intend to limit the present disclosure. Among the components in the below-described embodiments, a component which is not recited in the independent claims is described as an arbitrary component.

### Embodiment

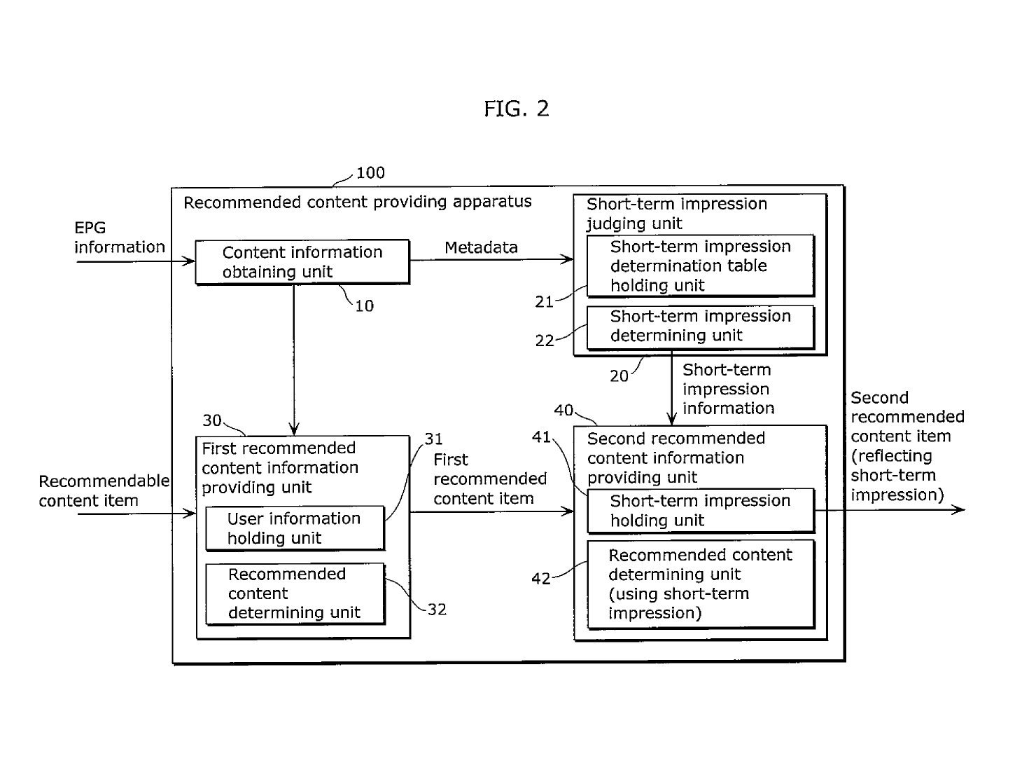

An embodiment of the content providing apparatus according to the present disclosure is described, referring to FIGS. 2 to 9.

In the present embodiment, description is given taking, as an example, a case where a recommended content providing apparatus 100 is installed in a television by which a digital terrestrial broadcasting can be viewed. In the present embodiment, description is also given taking, as an example, a case where content items are programs of the digital terrestrial broadcasting. Content categories indicating features of the content items are specified, in the present embodiment, by a genre, title, personal name, place name, keyword, or a combination of them, of the content item.

### [1. Configuration]

Configuration of the content providing apparatus is described, referring to FIG. 2. FIG. 2 is a block diagram which shows a configuration example of the recommended content providing apparatus 100 according to the present embodiment.

The recommended content providing apparatus 100 uses a first recommended content item based on a long-term preference, to calculate a second recommended content item by changing ranking of the first recommended content item so that the ranking of the content item having strong “just-viewed feeling” relatively degrades. The recommended content providing apparatus 100 includes, as shown in FIG. 2, a content information obtaining unit 10, a short-term impression judging unit 20, a first recommended content information providing unit 30, and a second recommended content information providing unit 40 (corresponding to a recommended content determining unit).

Upon detection of change in viewing content items in a television, the content information obtaining unit 10 obtains metadata of a viewing content item which is originally viewed before the change, i.e., the viewing content item viewing of which was finished, and transmits the metadata to the short-term impression judging unit 20 and the first recommended content information providing unit 30. Although description is given taking, as an example, a case where the metadata is obtained from an electronic program guide (EPG) information in the present embodiment, the present disclosure is not limited thereto. The metadata may be obtained, for example, from data superimposed on a broadcast wave, or from a server, on a network, which provides metadata in relation to the content item.

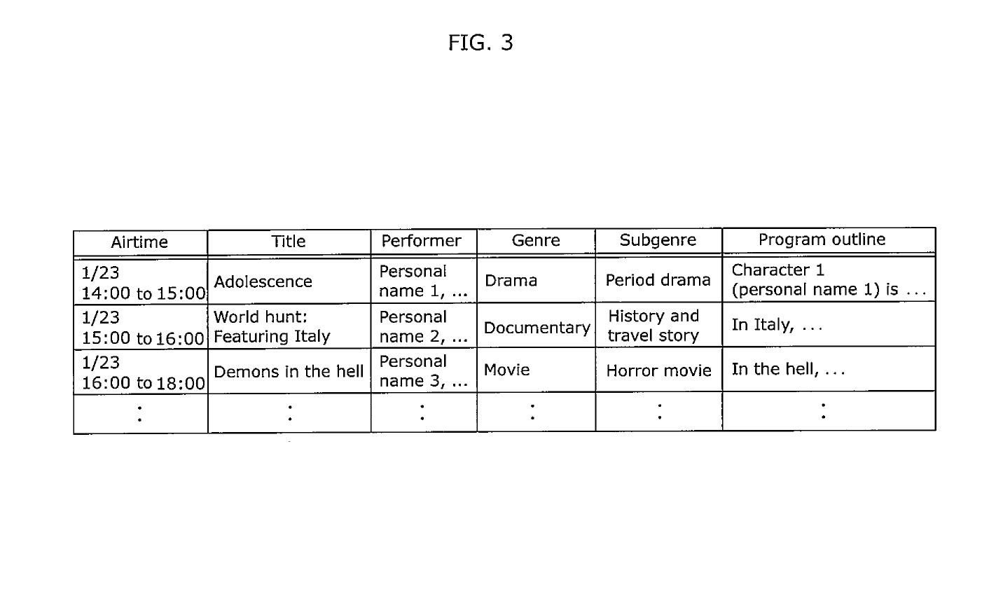

FIG. 3 is a table which shows an example of the metadata of the content item viewing of which was finished. The metadata has been transmitted to the short-term impression judging unit 20 and the first recommended content information providing unit 30 from the content information obtaining unit 10. The content information obtaining unit 10 obtains data of one line (one record) for one viewing content item and transmits the obtained data, in an example shown in FIG. 3. In the metadata shown in FIG. 3, “airtime”, “title”, “performer”, “genre”, “sub title”, and “program outline” are stored. In a case where the metadata obtained from the EPG information and the like contains information other than the information shown in FIG. 3, and an amount of data is large, only necessary information may be extracted and transmitted.

FIG. 3 shows that a user viewed, from 14:00 to 15:00 on January 23rd, a content item (TV broadcasting) which is titled “Adolescence” and belongs to a genre of “drama”. FIG. 3 also shows that the user viewed a content item which is titled “World hunt: Featuring Italy” and belongs to a genre of “documentary”, from 15:00 to 16:00 on the same day. FIG. 3 further shows that the user viewed a content item which is titled “Demons in the hell” and belongs to a genre of “movie” from 16:00 to 18:00 on the same day.

The short-term impression judging unit 20 produces, for the viewing content item whose metadata is transmitted, short-term impression information containing a viewing-finish time, the initial strength and impression duration of the “just-viewed feeling” for each of the content categories, and includes a short-term impression determination table holding unit 21 and a short-term impression determining unit 22.

The short-term impression determination table holding unit 21 holds a short-term impression determination table in which a short-term impression determination record containing the initial strength and impression duration of the “just-viewed feeling” (short-term impression) for each of the content categories is stored, in the present embodiment.

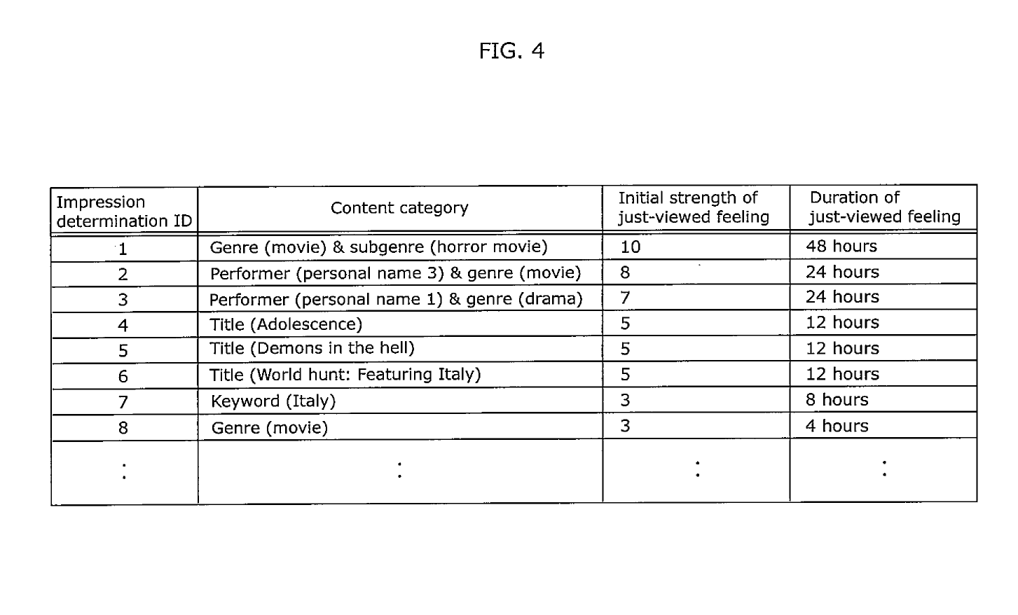

FIG. 4 is a table which shows an example of the short-term impression determination table stored in the short-term impression determination table holding unit 21. In the example shown in FIG. 4, an impression determination ID serving as identification information, a content category, and the initial strength and duration of the “just-viewed feeling” (short-term impression) are stored in a single short-term impression determination record. Also in the example shown in FIG. 4, a condition for determining the content category are set in each of the content categories, and are specified by a genre, subgenre, performer, title, and so on, or a combination of them. In the metadata containing a proper value including a personal name, title, and the like, information on the proper value has an effect on the “just-viewed feeling”. Accordingly, the proper value is used as the condition for determining the content category.

For example, the short-term impression determination record allocated to the impression determination ID 1 is set in such a manner that the content category is “genre (movie) and subgenre (horror movie)” and the initial strength of the “just-viewed feeling” (short-term impression) is 10, and the duration thereof is 48 hours. The short-term impression determination record allocated to the impression determination ID 8 is set in such a manner that the content category is “genre (movie)” and the initial strength of the “just-viewed feeling” (short-term impression) is 3, and the duration thereof is 3 hours.

In the present embodiment, the short-term impression determination table includes data previously recorded before determining the recommended content item for a user, and the description is given taking, as an example, a case where the initial strength and duration of the “just-viewed feeling” are previously set for each of the features of a content item. The initial strength and duration of the “just-viewed feeling” may be customized by a user, and the initial impression determination record may be added or deleted by a user.

The short-term impression determining unit 22 produces short-term impression information (short-term impression history record) based on the metadata obtained by the content information obtaining unit 10 and the short-term impression determination table stored in the short-term impression determination table holding unit 21.

To be specific, the short-term impression determining unit 22 extracts, from the short-term impression determination table, the short-term impression determination record having the content category coincident with a content category stored in the metadata, and obtains the initial strength and duration of the “just-viewed feeling” (short-term impression) stored in the extracted short-term impression determination record. The short-term impression determining unit 22 also accumulates, as a short-term impression history record, the “viewing-finish time” and the “content category” which are stored in the metadata, and the “initial strength of the just-viewed feeling” and the “duration of the just-viewed feeling” which are extracted from the short-term impression information, in a short-term impression holding unit 41 to be described later.

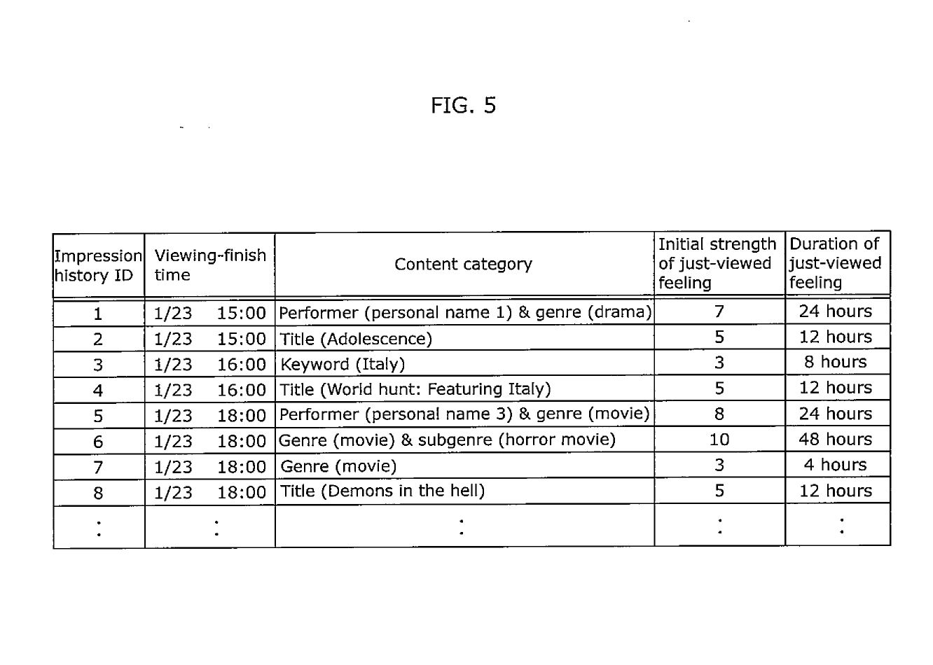

FIG. 5 shows an example of a short-term impression history table containing a plurality of the short-term impression history records to be stored in the short-term impression holding unit 41. In the example shown in FIG. 5, an impression history ID serving as identification information, a viewing-finish time, a content category, and the initial strength and duration of “the just-viewed feeling” (short-term impression) are stored in a single short-term impression history record.

A single content item may include a plurality of content categories. In this case, for a single content item, a plurality of short-term impression history records are stored for each of the content categories. In a content item which is shown in FIG. 3, for example, viewing of which was finished at 15:00 on January 23, two short-term impression determination records shown in FIG. 4 correspond to the content item. To be specific, the short-term impression determination record which is allocated to the impression determination ID 4 and belongs to the content category of “title (Adolescence)” and the short-term impression determination record which is allocated to the impression determination ID 3 and belongs to the content category of “performer (personal name 1) and genre (drama)” correspond to the content item viewing of which was finished at 15:00 on January 23.

The first recommended content information providing unit 30 determines the first recommended content item based on long-term preference information estimated from a viewing history in a long term, and includes a user information holding unit 31 and a recommended content determination unit 32.

The user information holding unit 31 holds information on a user's long-term preference (long-term preference information). The information on the user's long-term preference includes, for example, metadata accumulated over a long term (for example, one year) with respect to content items viewed a user, information (check-in information) on preference recorded by a user using an operational terminal and the like, browsing history on websites over a long term, activity history on a social network, and so on.

The recommended content determination unit 32 obtains information on a plurality of recommendable content items, that is metadata, and determines a first recommended content item which matches the user's long-term preference from among the obtained recommendable content items, based on the information on the user's long-term preference stored in the user information holding unit 31. The recommendable content items include, for example, a content item which is currently on the air or planned to start broadcasting, and are obtained from a server which provides, on the network, information on the content item. A well-known method can be employed here for determining the recommendable content item.

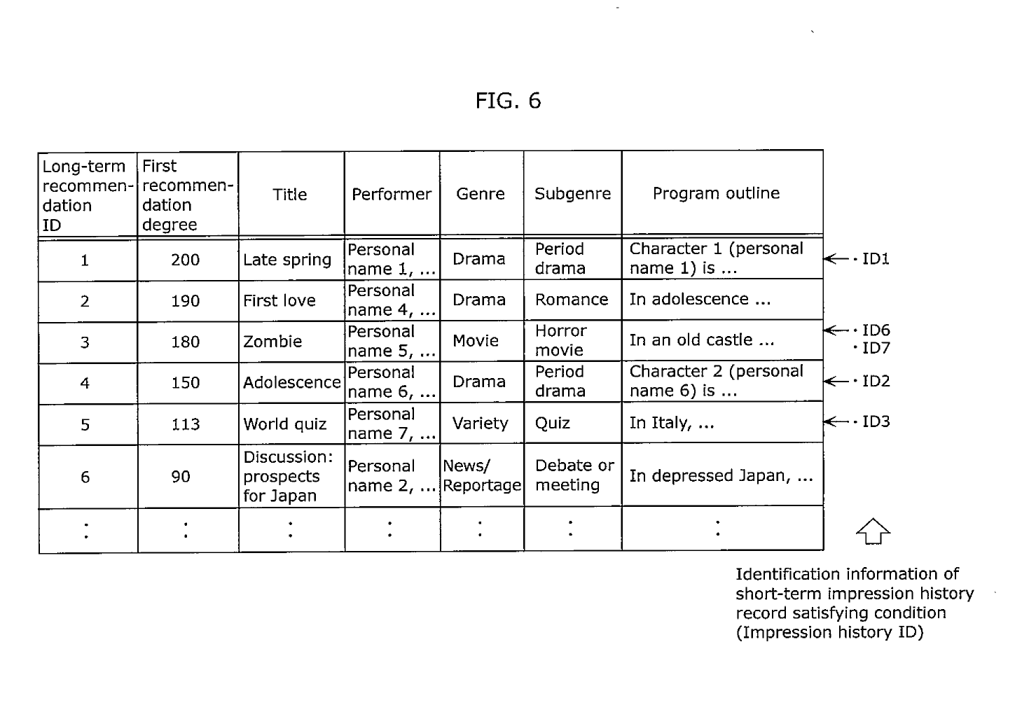

FIG. 6 is a table which shows an example of the metadata of the first recommended content item calculated by the first recommended content information providing unit 30. The metadata shown in FIG. 6 contains a long-term recommendation ID serving as the identification information, a first recommendation degree indicating the recommendation degree, a title, a performer, a genre, a subgenre, and a program outline.

The second recommended content information providing unit 40 determines a final recommended content item using the first recommended content item determined by the first recommended content information providing unit 30 and the “just-viewed feeling”, and includes the short-term impression holding unit 41 and a recommended content determining unit 42.

The short-term impression holding unit 41 holds the information on the “just-viewed feeling”, i.e., a short-term impression history table produced by the aforementioned short-term impression determining unit 22.

The recommended content determining unit 42 again determines the final recommended content item using the recommended content item which matches the user's long-term preference determined by the recommended content determining unit 32 and the short-term impression history table held in the short-term impression holding unit 41.

To be more specific, the recommended content determining unit 42 degrades the recommendation degree of the first recommended content item having the strong “just-viewed feeling”, with respect to first recommended content items which are shown in FIG. 6 and obtained by the first recommended content information providing unit 30. In other words, the recommended content determining unit 42 extracts the short-term impression history record whose content category matches the content category of any of the first recommended content items shown in FIG. 6, and modifies a first recommendation degree, taking into account the initial strength and duration of the extracted short-term impression history record and the elapsed time of the content item from the time point at which the viewing of the content item is finished, so as to calculate a final second recommendation degree. With this, a content item with fresh feeling without “just-viewed feeling”, which is selected based on the features of the content item, can be provided to a user at an appropriate timing.

### [2. Operation]

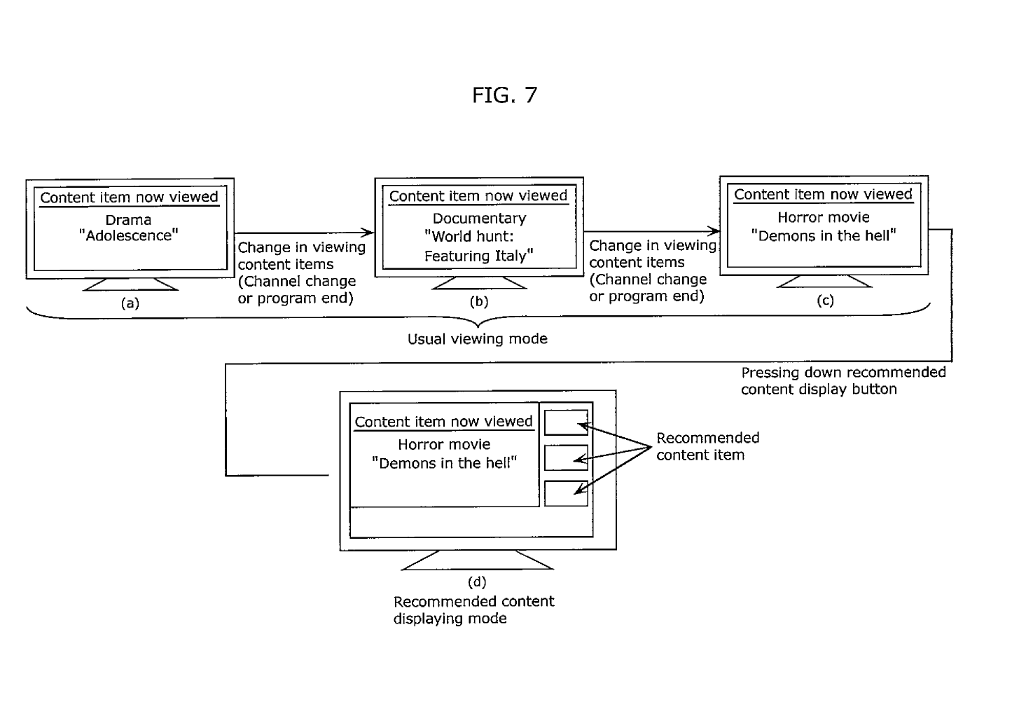

The following shall describe, with reference to FIGS. 7 to 9, a method for providing a recommended content item which reflects the “just-viewed feeling” using the recommended content providing apparatus 100 according to the present disclosure.

It should be noted that, in the present embodiment, a television equipped with the recommended content providing apparatus 100 is capable of switching modes between a usual viewing mode in which only a viewing content item is displayed on a television screen and a recommended content displaying mode in which a viewing content item and at least one of the recommended content items are simultaneously displayed on the television screen.

In the present embodiment, the recommended content providing apparatus 100 produces the short-term impression history table when the viewing content item is changed, and performs determination on the recommended content item when the usual viewing mode is switched to the recommended content displaying mode.

### [2.1 Television Screen Transition]

First, the change in the viewing content items and the switch in modes from the usual viewing mode to the recommended content displaying mode are described with reference to FIG. 7.

FIG. 7 is a schematic diagram which shows screen transition in the television screen. FIG. 7 shows modes (a) to (c) which are the usual viewing mode, and also shows a mode (d) which is the recommended content displaying mode. In the present embodiment, the usual viewing mode is switched to the recommended content displaying mode at a timing when a recommended content display button in a remote is pressed down.

FIG. 7 shows that a user viewed, in the usual viewing mode, programs in the order of a drama “Adolescence”, a documentary “World hunt: Featuring Italy”, and a horror movie “Demons in the hell”. FIG. 7 also shows that the user pressed the recommended content display button in the remote during viewing the horror movie “Demons in the hell”. Accordingly, the usual viewing mode is switched to the recommended content displaying mode between the modes (c) and (d). In the recommended content displaying mode, the content item which is now viewed is slightly reduced in screen size and displayed, and a plurality of recommended content items are displayed in the right side of the screen.

It should be noted that the change in the viewing content items under the usual viewing mode may include a case where a user changes channels, a case where airtime of the viewing content item is finished, or the like.

### [2.2 Short-Term Impression History Table Producing Method]

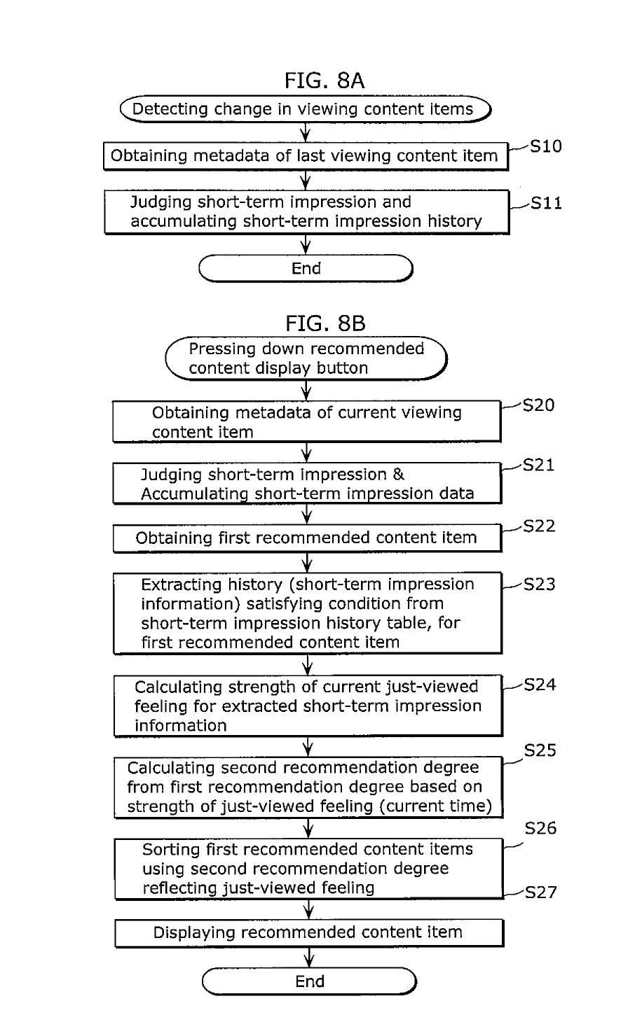

Next, the description is given to processing of producing a short-term impression history table, which is to be executed when the viewing content item is changed, with reference to FIG. 8A.

FIG. 8A is a flowchart which shows procedures in producing the short-term impression history table (a method for producing the short-term impression history table). The procedures are executed when the change in the viewing content items is detected.

When the change in the viewing content items is detected, the recommended content providing apparatus 100 obtains, from the EPG information, the metadata of the viewing content item before changing the viewing content items, which is the last viewing content item just finished to be viewed, using the content information obtaining unit 10, and transmits the obtained metadata to the short-term impression determining unit 22 in the short-term impression judging unit 20 (Step S10). In the present embodiment, description is given taking, as an example, a case where the metadata obtained by the content information obtaining unit 10 is the metadata shown in FIG. 3, and an amount of the data to be obtained corresponds to data for one line (one record).

Next, the recommended content providing apparatus 100 produces, using the short-term impression determining unit 22, the short-term impression information (short-term impression history record) including the initial strength and impression duration of the “just-viewed feeling”, for the metadata received from the content information obtaining unit 10, and accumulates the produced short-term impression information in the short-term impression holding unit 41 (Step S11).

To be more specific, since “title”, “performer”, “genre”, and “subgenre” are stored in the metadata of the viewing content item shown in FIG. 3, the short-term impression determining unit 22 uses these data items as a condition, and performs searching on the content categories in the short-term impression determining table shown in FIG. 4, and extracts the short-term impression determination record having the content category which matches the condition. Furthermore, the short-term impression determining unit 22 produces the short-term impression history record to which the viewing-finish time is added, for each of the extracted short-term impression determination records, and accumulates the produced short-term impression history records in the short-term impression holding unit 41.

For example, among the metadata shown in FIG. 3, the title (Adolescence), performer (personal name 1), genre (drama), and subgenre (period drama) are stored in the metadata shown in the first line in the table of FIG. 3. The short-term impression determining unit 22 sequentially obtains the content categories of each of the short-term impression determination records composing the short-term impression determination table shown in FIG. 4, and judges whether or not the obtained category satisfies the condition. In an example shown in FIG. 4 in the present embodiment, two short-term impression determination records satisfy the condition of the metadata. The two short-term impression determination records are a record allocated to the impression determination ID 3 for “performer (personal name 1) and genre (drama)” and a record allocated to the impression determination ID 4 for “title (Adolescence)”. The short-term impression determining unit 22 extracts the initial strength and duration of the “just-viewed feeling” from the two short-term impression determination records which satisfy the condition. Furthermore, the short-term impression determining unit 22 produces the short-term impression history record to which the viewing-finish time (15:00) is added, for each of the two short-term impression determination records, and accumulates the produced short-term impression history records in the short-term impression holding unit 41. The short-term impression history records produced at this stage are respectively the short-term impression history record of “performer (personal name 1) and genre (drama)” allocated to the impression history ID 1 and the short-term impression history record of “title (Adolescence)” allocated to the impression history ID 2, in the short-term impression history table shown in FIG. 5.

In addition, FIG. 3 shows the metadata in the second line, in which title (World hunt: Featuring Italy), performer (personal name 3), genre (documentary), subgenre (history and travel story) are stored, and a keyword (Italy) is also stored in the program outline. The short-term impression determining unit 22 extracts, as the short-term impression determination record satisfying the condition of the content categories, two short-term impression determination records including the short-term impression determination record of “title (World hunt: Featuring Italy)” allocated to the impression determination ID 6 and the short-term impression determination record of “keyword (Italy)” allocated to the impression determination ID 7, from the short-term impression determination table shown in FIG. 4, produces the short-term impression history records to which the viewing-finish time (16:00) is added, and accumulates the produced short-term impression history records in the shot-term impression holding unit 41. The short-term impression history records produced at this stage are two short-term impression history records, such as the impression history ID 3 and the impression history ID 4 in the short-term impression history table shown in FIG. 5.

In addition, FIG. 3 shows the metadata in the third line among the metadata items, for example, in which the title (Demons in the hell), performer (personal name 3), genre (movie), and subgenre (horror movie) are stored. The short-term impression determining unit 22 extracts from the short-term impression determination table, as the short-term impression determination records satisfying the condition of the content categories, four short-term impression determination records, such as a record which is allocated to the impression determination ID 1 and has “genre (movie) and subgenre (horror movie)”, a record which is allocated to the impression determination ID 2 and has “performer (personal name 3) and genre (movie)”, a record which is allocated to the impression determination ID 8 and has “genre (movie)”, and a record which is allocated to the impression determination ID 5 and has “title (Demons in the hell)”, produces the short-term impression history records to which the viewing-finish time (18:00) is added, and accumulates the produced short-term impression history records in the short-term impression holding unit 41. The short-term impression history records produced at this stage are four short-term impression history records, such as the impression determination ID 5 to impression determination ID 8 in the short-term impression history table shown in FIG. 5.

### [2.3 Recommended Content Providing Method]

Next, a method for providing a recommended content item is described with reference to FIG. 8B.

FIG. 8B is a flowchart which shows procedures in providing the recommended content item (recommended content providing method). The procedures are executed when a user presses a recommended content display button in a television.

When the recommended content display button is pressed down, the content information obtaining unit 10 first obtains metadata of the viewing content item which is now viewed, and transmits the obtained metadata to the second recommended content information providing unit 40 via the short-term impression determining unit 22 (Step S20).

Next, the short-term impression determining unit 22 produces short-term impression information containing initial strength and impression duration of the “just-viewed feeling” for the metadata of the viewing content item which is now viewed and is received from the content information obtaining unit 10, and accumulates the produced short-term impression information in the short-term impression holding unit 41 (Step S21). The procedures in the Step S21 are the same with those in the Step S11, except for addition of a viewing-finish time. In Step S11, the viewing-finish time is added to the short-term impression information to be accumulated. However, in Step S11, the content item is now viewed, so that the viewing-finish time is not fixed. Accordingly, the current time is stored as a tentative viewing-finish time. At this time, the impression history ID of the short-term impression information, in which the viewing-finish time is tentatively set is held, and the viewing-finish time of the impression history ID is reset when the viewing content item is changed. In other words, since the processing of producing the short-term impression history table shown in FIG. 8A has been already executed during viewing the viewing content item, the viewing-finish time is only reset without again executing the processing of producing the short-term impression history table.

The second recommended content information providing unit 40 obtains a first recommended content item from the first recommended content information providing unit 30 (Step S22). In the present embodiment, when the recommended content display button is pressed down, the first recommended content information providing unit 30 determines, using the recommended content determining unit 32, a first recommended content item satisfying a user's long-term preference among recommendable content items, based on the user's long-term preference information stored in the user information holding unit 31.

Next, the second recommended content information providing unit 40 extracts, from the short-term impression history table held in the short-term impression holding unit 41, a short-term impression history record having the content category which matches that of the first recommended content item, for each of the first recommended content items which match the user's long-term preference outputted from the first recommended content information providing unit 30 (Step S23). If the short-term impression history record which belongs to the same content category exists, the second recommended content information providing unit 40 extracts the latest short-term impression history record. In other words, for one content category, one short-term impression history record is extracted.

For example, FIG. 6 shows metadata items of the first recommended content items including the content item allocated to a long-term recommendation ID 1 in which a first recommendation degree (200), title (Late spring), performer (personal name 1), genre (drama), and subgenre (period drama) are stored. If the search is performed on the short-term impression history table shown in FIG. 5 using these data items as a condition, the short-term impression history record of “performer (personal name 1) and genre (drama)” allocated to the impression history ID 1 is extracted. Similarly, in the content item allocated to the long-term recommendation ID 3, the first recommendation degree (180), title (Zombie), performer (personal name 5), genre (movie), and subgenre (horror movie) are stored. If search is performed on the short-term impression history table shown in FIG. 5 using these data items as a condition, the short-term impression history record of “genre (movie) and subgenre (horror movie)” allocated to the impression history ID 6 and the short-term impression history record of “genre (movie)” allocated to the impression history ID 7 which are shown in FIG. 5 are extracted. In addition, in the content item allocated to the long-term recommendation ID 4, the first recommendation degree (150), title (Adolescence), performer (personal name 6), genre (drama), and subgenre (period drama) are stored. If search is performed on the short-term impression history table shown in FIG. 5 using these data items as the condition, the short-term impression history record of “title (Adolescence)” allocated to the impression history ID 2 shown in FIG. 5 is extracted. In the content item allocated to the long-term recommendation ID 5, the first recommendation degree (113), title (World quiz), performer (personal name 7), genre (variety program), and subgenre (quiz) are stored. Here, a keyword (Italy) is also stored in the program outline. If search is performed on the short-term impression history table shown in FIG. 5 using these data items as the condition, the short-term impression history record of “keyword (Italy)” allocated to the impression history ID 3 shown in FIG. 5 is extracted.

Next, the second recommended content information providing unit 40 performs calculation on strength of the short-term impression at present (current strength) in relation to the “just-viewed feeling” for each of the short-term impression history records extracted in Step S23, as shown in FIG. 8B. The current strength of the “just-viewed feeling” in the present embodiment can be calculated by a below-shown equation 1.

Current strength=initial strength×(impression duration−(current time−viewing-finish time))/impression duration (1)

Here, if the elapsed time from the viewing-finish time is longer than the impression duration, that is, (impression duration of “just-viewed feeling”−(current time−viewing-finish time))<0, the current strength=0 should be set.

For example, consideration is given to a case where the current time is 18:00. Here, the impression history ID 1 in FIG. 5 has the initial strength of the “just-viewed feeling” of 7, the impression duration of the “just-viewed feeling” of 24 hours, and the viewing finish time of 15:00. For the occasion, the current strength of the “just-viewed feeling” of the short-term impression history record allocated to the impression history ID 1 can be drawn by 7×(24−(18−15))/24=6.125. Similarly, the current strength of the “just-viewed feeling” of the short-term impression history record allocated to the impression history ID 2 is drawn by 5×(12−(18−15))/12=3.75. The current strength of the “just-viewed feeling” of the short-term impression history record allocated to the impression history ID 3 is drawn by 3×(8−(18−16))/8=2.25. The current strength of the “just-viewed feeling” of the short-term impression history record allocated to the impression history ID 6 is drawn by 10×(48−(18−18))/48=10. The current strength of the “just-viewed feeling” of the short-term impression history record allocated to the impression history ID 7 is drawn by 3×(4−(18−18))/4=3.

Next, the second recommended content information providing unit 40 performs calculation on the second recommendation degree reflecting the “just-viewed feeling”, based on the current strength of the “just-viewed feeling” and the first recommendation degree, as shown in FIG. 8B (Step S25). The second recommendation degree (after the “just-viewed feeling” is reflected) in the present embodiment can be calculated by a below-shown equation 2.

Second recommendation degree=first recommendation degree×Πweight coefficient (2)

When a plurality of the short-term impression history records are extracted for the first recommended content item, the weight coefficient is calculated for each of the short-term impression history records, followed by multiplying the all calculated weight coefficients by the first recommendation degree, to thereby calculate the second recommendation degree. It should be noted that the weight coefficient depends on the current time and can be calculated by a below-shown equation 3.

Weight coefficient=(maximum strength of the “just-viewed feeling”−the current strength of the “just-viewed feeling”)/the maximum strength of the “just-viewed feeling” (3)

Here, the maximum strength of the “just-viewed feeling” is set to the maximum value of the initial strength of the “just-viewed feeling” stored in the short-term impression determination table shown in FIG. 4. The maximum value is set to 10 in the example shown in FIG. 4.

When the short-term impression history record allocated to the impression history ID 1 shown in FIG. 5 belongs to the content category of “performer (personal name 1) and genre (drama)”, for example, the weight coefficient is drawn by (10−6.125)/10=0.3875. Similarly, in FIG. 5, the weight coefficient of the impression history record allocated to the impression history ID 2 is drawn by (10−3.75)/10=0.625, the weight coefficient of the impression history record allocated to the impression history ID 3 is drawn by (10−2.25)/10=0.775, the weight coefficient of the impression history record allocated to the impression history ID 6 is drawn by (10−10)/10=0, and the weight coefficient of the impression history record allocated to the impression history ID 7 is drawn by (10−3)/10=0.7.

Accordingly, the second recommendation degree of the content item having title of “Late spring” allocated to the long-term recommendation ID 1 shown in FIG. 6 is drawn by: the first recommendation degree of 200×weight coefficient of 0.3875=77.5. Similarly, the second recommendation degree of the content item allocated to the long-term recommendation ID 4 is drawn by 150×0.625=93.75, while the second recommendation degree of the content item allocated to the long-term recommendation ID 5 is drawn by 113×0.775=87.575. For the content item allocated to the long-term recommendation ID 3, two short-term impression history records are extracted, so that two weight coefficients are needed. Accordingly, the second recommendation degree of the long-term recommendation ID 3 is drawn by 180×(0×0.7)=0.

Here, for the first recommended content item from which the short-term impression history record has not been extracted in Step S23, the second recommendation degree is set to be equal to the first recommendation degree.

Next, the second recommended content information providing unit 40 performs sorting on the first recommended content items obtained from the first recommended content information providing unit 30, using a value of the second recommendation degree reflecting the “just-viewed feeling”, and outputs a result of the sorting, as shown in FIG. 8B (Step S26).

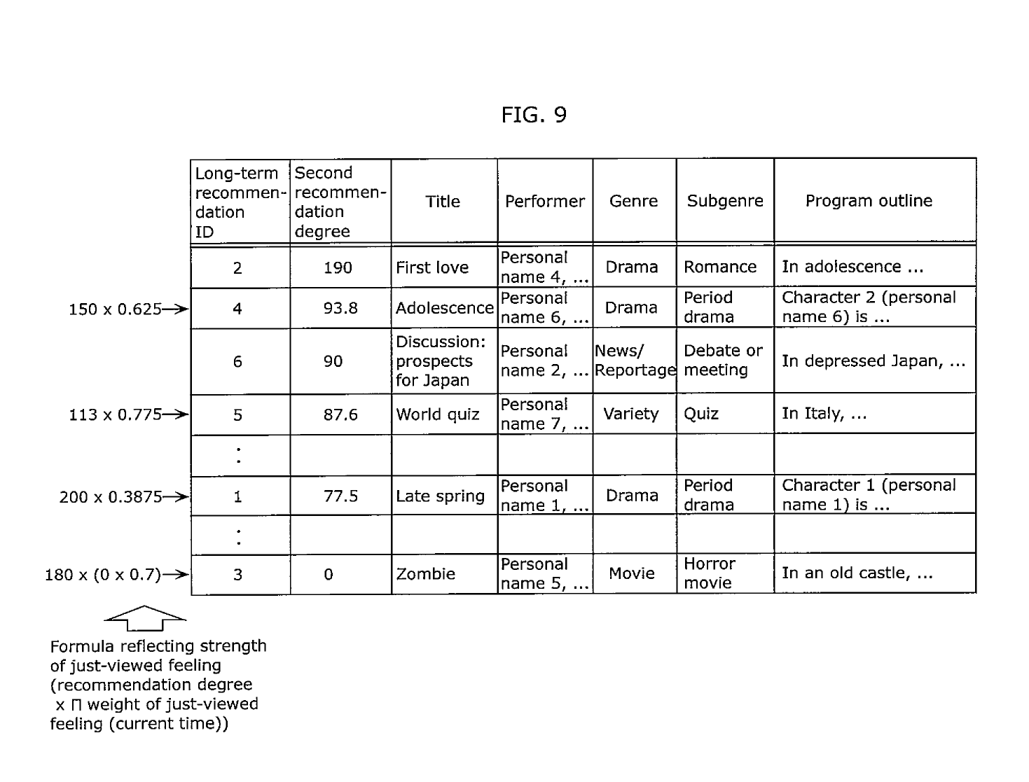

FIG. 9 is a table which shows an example of the sorting result for the first recommended content items. In a single record, the second recommendation degree re-determined by the second recommended content information providing unit 40, the long-term recommendation ID set in the first recommended content information providing unit 30, title, performer, genre, subgenre, and program outline are stored.

Some of the second recommendation degrees of the second recommended content items shown in FIG. 9 are different from the first recommendation degrees of the first recommended content items shown in FIG. 6. To be specific, the content item allocated to the long-term recommendation ID 1 has the first recommendation degree of 200 in FIG. 6, while the second recommendation degree of the content item after the “just-viewed feeling” is reflected becomes 77.5, as shown in FIG. 9. The content item allocated to the long-term recommendation ID 3 has the first recommendation degree of 180 in FIG. 6, while the second recommendation degree thereof is 0, as shown in FIG. 9. The content item allocated to the long-term recommendation ID 4 has the first recommendation degree of 150 in FIG. 6, while the second recommendation degree thereof is 93.8, as shown in FIG. 9. The content item allocated to the long-term recommendation ID 5 has the first recommendation degree of 113 in FIG. 6, while the second recommendation degree thereof is 87.6, as shown in FIG. 9.

In the present embodiment, the second recommended content information providing unit 40 sets, as the second recommended content item, a content item other than the first recommended content item having the second recommendation degree of 0, and outputs metadata of the second recommended content items in the descending order of the second recommendation degree. The second recommended content information providing unit 40 may also output metadata indicating the second recommend content item and the second recommendation degree. Alternatively, all of the first recommended content items may be set to be the second recommended content items, and the metadata of the all of the first recommended content items may be outputted in association with the second recommendation degree.

Next, the recommended content providing apparatus 100 displays the second recommended content item reflecting the “just-viewed feeling”, on a television screen (Step S27). In the present embodiment, as shown in the mode (d) of FIG. 7, the content item which is now viewed is slightly reduced in size and displayed on the upper left of the screen, and a plurality of recommended content items are displayed in the right side of the screen. In the mode (d) in FIG. 7, three areas are prepared for displaying the recommended content items, and three images indicating the respective three second recommended content items are displayed in the descending order of the second recommendation degree. In the sorting result shown in FIG. 9, images reflecting the content items of the respective long-term recommendation IDs 2, 4, and 6 are displayed.

As described above, in the content providing apparatus according to the present disclosure, the initial strength and duration of the “just-viewed feeling” according to the features of the content item are used to eliminate the necessity of estimation of a user's short-term preference information, to thereby enable a content item which is fresh for the user without the “just-viewed feeling” to be recommended to a user, from a user's viewing history

### Other Embodiments

(1) In the aforementioned embodiment, a timing of switching to a recommended content displaying mode in which a recommended content item is displayed is a time point when a recommended content display button in a remote is pressed down. However, the timing is not limited thereto. For example, the recommended content item may be displayed at another timing, for example, when a user detects zapping, when menu of a recorder or a set top box which are connected to a television is displayed, when letters for searching a content item are inputted, or at a plurality of timings among the aforementioned timings.

(2) In the aforementioned embodiment, the second recommended content item is determined by sorting and ranking the first recommended content items using level of the second recommendation degree. However, the present disclosure is not limited thereto. For example, the second recommended content item may be determined in such a manner that the first recommended content items are sorted based on the first recommendation degree, and subsequently ranking on the first recommended content items is performed by degrading the first recommended content items having corresponding short-term impression history information, based on a value of the current strength of the “just-viewed feeling”. In addition, the second recommended content item may be determined by, for example, other ways, such as, by deleting the first recommended content item having the corresponding short-term impression history information among the first recommended content items.

(3) In the aforementioned embodiment, the description was given taking as an example the case where the recommended content providing apparatus 100 is installed in a television. However, part of or all of the content information obtaining unit 10, the short-term impression judging unit 20, the first recommended content information providing unit 30 and the second recommended content information providing unit 40 may be installed in a set top box, a server, and the like. For the occasion, the recommended content providing apparatus 100 may be configured to be capable of identifying the viewing content item currently viewed by a user.

(4) In the aforementioned embodiment, the description was given taking as an example the case where the strength of the “just-viewed feeling” decreases at a constant rate after viewing is finished, as shown in FIG. 1. However, the present disclosure is not limited thereto. For example, the strength of the “just-viewed feeling” may be set at a level of initial strength for a certain period of time after the viewing is finished, or may be set to have a reduction rate which increases as time passes. The relationships between the strength of the “just-viewed feeling” and the elapsed time may be differentiated depending on the content categories. Since the strength of the “just-viewed feeling” and the elapsed time are assumed to have the relationship shown in FIG. 1, in the present embodiment, the description was given taking as an example a case where the short-term impression determination table holding unit 21 includes a short-term impression determination table shown in FIG. 4. However, when the relationship between the strength of the “just-viewed feeling” and the elapsed time is different from that in FIG. 1, information with which the current strength of the “just-viewed feeling” can be specified is stored at an arbitrary current time.

(5) In the aforementioned embodiment, the recommended content providing apparatus 100 includes the first recommended content information providing unit 30. However, the first recommended content information providing unit 30 is not indispensable component. The first recommended content information providing unit 30 may be formed in the outside of the recommended content providing apparatus 100, for example, in a server and the like provided on the network. In this case, the recommended content providing apparatus 100 can obtain metadata of the first recommended content item and the recommendation degree from the first recommended content information providing unit 30 through the network and the like.

(6) In the aforementioned present disclosure, the short-term impression determination unit 22 produces short-term impression history records for all of short-term impression determination records extracted based on metadata of the viewing content items in Step S11, and the second recommended content information providing unit 40 extracts a latest short-term impression history record when the short-term impression history records having the same content category exist in Step S23. However, the present disclosure is not limited thereto.

For example, if no short-term impression history record exists which matches, in the content category, any of the short-term impression determination records extracted based on the metadata of the viewing content item, the short-term impression determining unit 22 may newly produce the short-term impression history records. If the short-term impression history record which matches the short-term impression determination record in the content category exists, the short-term impression determining unit 22 may overwrite the viewing-finish time.

The information items on a single content item should not be reflected on the second recommendation degree redundantly.

(7) Each of the functional blocks shown in the block diagram (FIG. 2) is typically achieved as an LSI which is an integrated circuit, in the aforementioned embodiment. Each of these blocks may be individually formed as a single chip, or part or all of them may be formed on a single chip. In the present disclosure, the integrated circuit of this description employs the LSI. However, the integrated circuit may be called as an IC, a system LSI, a super LSI, or an ultra LSI.

The integrated circuit is not limited to be formed by the LSI, but a dedicated circuit or a general-purpose processor may be used to achieve the integrated circuit. A field programmable gate array (FPGA) which can be programmed after the LSI is produced, or a reconfigurable processor which can reconfigure connection or setting of circuit cells inside the LSI may be used.

Furthermore, if an integrated-circuit configuring technique which substitutes for the LSI is achieved along with technical advance in a semiconductor field or by a derived different technique, the technique may be naturally used to integrate the functional blocks. Biotechnology may be applied as one of possibilities.

In the aforementioned embodiment, each of the components may be configured by dedicated hardware. Alternatively, components which can be achieved by software may be achieved by executing a program.

Although embodiments of the present disclosure are described with reference to the drawings, the present disclosure is not limited thereto. Various modifications, addition, or change can be made to the aforementioned embodiments within a range identical to that of the present disclosure, or in a range equivalent to that of the present disclosure.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

According to the present disclosure, a content item which is fresh for a user without “just-viewed feeling” can be recommended from large quantity of viewing content items in a market, so that content items can be discovered efficiently. For a provider who provides a recommended content item, the present disclosure is also usable as a method for providing more opportunities to a user to view a large quantity of content items possessed by the provider.

1. A recommended content providing apparatus comprising:
an obtaining unit configured to obtain information on display of a plurality of recommended content items;
a short-term impression judging unit configured to obtain impression duration of a viewing content item viewed by a user; and
a recommended content determining unit configured to modify the information on display of one of the recommended content items which belongs to a same content category as a content category to which the viewing content item belongs, based on the impression duration of the viewing content item.

2. The recommended content providing apparatus according to claim 1,
wherein the obtaining unit is configured to obtain recommendation degrees of the recommended content items, as the information on display, and
the recommended content determining unit is configured to modify at least one of the recommendation degrees which corresponds to the recommended content item.

3. The recommended content providing apparatus according to claim 2,
wherein the recommended content determining unit is further configured to determine a priority order for displaying the recommended content items, based on the modified recommendation degrees.

4. The recommended content providing apparatus according to claim 2,
wherein the recommended content determining unit is further configured to determine whether or not the recommended content items are to be displayed, based on the modified recommendation degrees.

5. The recommended content providing apparatus according to claim 2,
wherein the short-term impression judging unit is configured to obtain viewing-finish time of the viewing content item in addition to the impression duration, and
the recommended content determining unit is configured to modify the information on display, based on impression duration of a viewing content item which does not accomplish the impression duration from the viewing-finish time, among viewing content items including the viewing content item.

6. The recommended content providing apparatus according to claim 2,
wherein the recommended content determining unit is configured to modify each of the recommendation degrees to reduce the recommendation degree greater for the recommended content item corresponding to the viewing content item the impression duration of which is longer.

7. The recommended content providing apparatus according to claim 1,
wherein the short-term impression judging unit is configured to obtain viewing-finish time of the viewing content item and initial strength of impression on the viewing content item, in addition to the impression duration, and
the recommended content determining unit is configured to calculate, for the viewing content item, current strength indicating strength of current impression, based on elapsed time from the viewing-finish time, the impression duration, and the initial strength, to thereby modify the information on display based on the current strength.

8. The recommended content providing apparatus according to claim 7,
wherein the recommended content determining unit is configured to calculate the current strength by multiplying the initial strength by a ratio, to the impression duration, of a difference between the impression duration and the elapsed time.

9. The recommended content providing apparatus according to claim 7,
wherein the obtaining unit is configured to obtain a recommendation degree of each of the recommended content items, as the information on display, and
the recommended content determining unit is configured to calculate a value, as a weight coefficient, by dividing a difference between a maximum value of the initial strength and a value of the current strength by the maximum value of the initial strength, and to multiply the recommendation degree by the weight coefficient, to thereby modify the recommendation degree.

10. The recommended content providing apparatus according to claim 7,
wherein the obtaining unit is configured to obtain a recommendation degree of each of the recommended content items, as the information on display, and
the recommended content determining unit is configured to modify the recommendation degree to reduce the recommendation degree greater for the recommended content item corresponding to the viewing content item the impression duration of which is longer.

11. The recommended content providing apparatus according to claim 1,
wherein the content category is specified by at least any one of a content genre, a keyword contained in metadata of the viewing content item, a personal name who appears in the viewing content item, a title of the viewing content item, and a combination thereof.

12. A non-transitory computer-readable recording medium in which a recommended content providing program is stored for causing a computer to execute determination on a content item to be provided to a user, the recommend content providing program comprising:
obtaining information on display of a plurality of recommended content items;
obtaining impression duration of a viewing content item viewed by a user; and
modifying the information on display of one of the recommended content items which belongs to a same content category as a content category to which the viewing content item belongs, based on the impression duration of the viewing content item.

13. A recommended content providing method comprising:
obtaining information on display of a plurality of recommended content items;
obtaining impression duration of a viewing content item viewed by a user; and
modifying the information on display of one of the recommended content items which belongs to a same content category as a content category to which the viewing content item belongs, based on the impression duration of the viewing content item.

14. A content providing apparatus comprising:
a first obtaining unit configured to obtain information on a plurality of recommended content items;
a second obtaining unit configured to obtain an attribute information item on a viewing content item viewed by a user;
a time information determining unit configured to determine time information set for each of attribute information items including the attribute information item, as impression duration of the viewing content item; and
a priority determining unit configured to determine a priority on each of the recommended content items, based on elapsed time from viewing-finish time, the impression duration, and the information on the recommended content items.
